(19) United States
(12) Patent Application Publication
(10) Pub. No.: US 2025/0187117 A1
(43) Pub. Date: Jun. 12, 2025

(54) LASER CUTTING OF A WORKPIECE WITH PROTECTION BY THE MACHINING DEVICE

(71) Applicant: TRUMPF Werkzeugmaschinen SE + Co. KG, Ditzingen (DE)

(72) Inventors: Winfried Magg, Ditzingen (DE); Bernd Renz, Benningen am Neckar (DE)

(21) Appl. No.: 19/059,321

(22) Filed: Feb. 21, 2025

Related U.S. Application Data
(63) Continuation of application No. PCT/EP2023/070408, filed on Jul. 24, 2023.

(30) Foreign Application Priority Data
Aug. 24, 2022 (DE) 10 2022 121 341.2

(51) Int. Cl. B23K 26/38; B23K 26/02

(52) U.S. Cl. CPC B23K 26/38; B23K 26/02

(57) ABSTRACT

A method for monitoring a process of cutting a workpiece with a laser beam includes irradiating a top side of the workpiece with a laser beam, and cutting through the workpiece with the laser beam with a cut from the top side of the workpiece to an underside of the workpiece, the underside of the workpiece being opposite the top side of the workpiece in a beam direction of the laser beam, thereby forming a cutting front and a kerf. The method further includes limiting a power of a part of the laser beam that has passed through the workpiece to a predetermined level. The part of the laser beam having passed through exits from the workpiece on the underside of the workpiece when cutting through the workpiece.

### CROSS REFERENCE TO RELATED APPLICATIONS

This application is a continuation of International Application No. PCT/EP2023/070408 (WO 2024/041823 A1), filed on Jul. 24, 2023, and claims benefit to German Patent Application No. DE 10 2022 121 341.2, filed on Aug. 24, 2022. The aforementioned applications are hereby incorporated by reference herein.

### FIELD

Embodiments of the present invention relate to a method for monitoring a process of cutting a workpiece with a laser beam, and to a machining device for carrying out such a method.

### BACKGROUND

DE 10 2018 218 006 A1 discloses a fusion cutting method in which a characteristic length of a cutting front is determined by an imaging sensor and regulated to a predetermined target length to avoid errors during cutting, in particular cut breaks. Similarly, WO 2012/107331 A1 deals with the determination of characteristic geometric parameters of the cutting front and a kerf in a laser cutting method for controlling the cutting method with the aid of a camera.

### SUMMARY

Embodiments of the present invention provide a method for monitoring a process of cutting a workpiece with a laser beam. The method includes irradiating a top side of the workpiece with a laser beam, and cutting through the workpiece with the laser beam with a cut from the top side of the workpiece to an underside of the workpiece, the underside of the workpiece being opposite the top side of the workpiece in a beam direction of the laser beam, thereby forming a cutting front and a kerf. The method further includes limiting a power of a part of the laser beam that has passed through the workpiece to a predetermined level. The part of the laser beam having passed through exits from the workpiece on the underside of the workpiece when cutting through the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a cross-section through a machining device for the controlled cutting of a workpiece with a laser beam according to some embodiments;

FIG. 2 schematically shows a cross-section through the irradiated workpiece on a support according to some embodiments;

FIG. 3 schematically shows a process image of a process of cutting in a first embodiment; and

FIG. 4 schematically shows a process diagram of a process of cutting in a second embodiment.

### DETAILED DESCRIPTION

Embodiments of the present invention concern the production of a high-quality cut of a workpiece.

Embodiments of the present invention provide a method for cutting through a workpiece with a laser beam in which the surroundings of the workpiece are better protected from the laser beam, in particular a support for the workpiece. It is also an object of the invention to provide a machining device for carrying out the method.

The method according to embodiments of the invention has the following steps:
a) irradiating a top side of the workpiece with a laser beam;
b) cutting through the workpiece with the laser beam with a cut from the top side of the workpiece to an underside of the workpiece, wherein the underside of the workpiece is opposite the top side of the workpiece in the beam direction of the laser beam, and forms a cutting front and a kerf;
c) limiting the power of a part of the laser beam that has passed through the workpiece to a predetermined level, wherein the part of the laser beam having passed through the workpiece exits the workpiece on the underside of the workpiece when cutting through the workpiece.

The method is particularly effective for cutting methods using laser devices that emit a laser beam with high power. As a result, in these methods, a part of the laser beam that is not absorbed by the workpiece but is emitted into the machine space of the machining device in question can also transport a high amount of energy. In particular, part of the laser beam radiates through a workpiece that is to be processed by the process of cutting. This poses the risk that the machine will be damaged by local heating or even fail completely.

By regulating this part, the emitted power of the laser beam can be reduced, typically by increasing the cutting speed and/or reducing the power of the laser beam to prevent damage to the machining device. The power of the part of the laser beam that passes through the workpiece is determined, for example, as the difference between the power with which the entire laser beam acts on the surface of the workpiece and the power with which the laser beam hits the cutting front. A predetermined value to which the power of the laser beam is limited can be determined, among other things, by previous tests on identical workpieces. In particular, method parameters can be determined for achieving a predetermined power of the part of the laser beam that has passed through the workpiece in a predetermined time interval.

A cutting front is preferably understood to mean the material of the workpiece or the geometric shape of the material of the workpiece, wherein this material is irradiated and melted or vaporized at a time when the workpiece is irradiated by the laser beam. The cutting front moves with the laser beam. A kerf is preferably understood to be the gap that is created by the removal of material from the workpiece during the process of cutting. The kerf is usually located behind the cutting front in the feed direction of the laser beam. The cutting front and the kerf act particularly like an aperture on the laser beam. The power of the part of the laser beam that passes through the workpiece is preferably referred to as power surplus, in other words the part or proportion of the power of the laser beam that is not used for cutting the workpiece.

The method according to embodiments of the invention can also be applied if the contour cut of a workpiece has been interrupted and the workpiece is to be further cut after resuming the cutting method. To do this, the cutting head is usually moved back a comparatively small distance along the cutting contour and then continues cutting over the contour that has already been cut. A large part of the power of the laser beam can pass through the already cut kerf. The determination of the power surplus can be used to control the power of the part of the laser beam that passes through the workpiece.

A preferred embodiment of the method includes determining a characteristic value for the power of the part of the laser beam that has passed through the workpiece. The power of the part of the laser beam that passes through the workpiece is determined, for example, as the difference between the power with which the entire laser beam acts on the surface of the workpiece and the power with which the laser beam hits the cutting front. Among other things, the difference between the power with which the entire laser beam acts on the surface of the workpiece and the power with which the laser beam acts on the cutting front can be used as a characteristic value for the power of the part of the laser beam passing through the workpiece. Alternatively or additionally, ratios of the power of the part of the laser beam that has passed through to the part of the laser beam absorbed by the workpiece and/or to the power of the entire laser beam can be used as characteristic values. The part of the laser beam power that is reflected from the cutting front usually has a comparatively small effect on a machining device used and is therefore preferably neglected. Advantageously, characteristic values provide a concrete indication of the power of the part of the laser beam that has passed through the workpiece, which can be used in the control process. By determining the power of the part of the laser beam that radiates through the workpiece, it can be determined whether a machining device used to perform the cutting operation is supplied with too much energy by that part of the laser beam during the cutting operation, causing damage to the machining device. This allows the cutting method to be monitored in such a way that damage to the machining device is prevented.

In some embodiments of the method, the absorbed power part of the laser beam can be determined by integrating the laser power distribution over the area of the cutting front and can be subtracted from the power of the total laser beam to determine the power surplus. Alternatively or additionally, a characteristic value for the power surplus can be determined by integrating the laser power distribution over the area of the kerf.

According to an advantageous embodiment of the method, the power of the part of the laser beam that has passed through is determined using the output power of the laser source for generating the laser beam, the caustic of the laser beam, the Rayleigh length of the laser beam, the position of the focus of the laser beam, the focus position, the focus diameter, the workpiece thickness and/or the distance of a cutting nozzle from which the laser beam exits to the workpiece. The specified parameters determine in particular the position, shape, and power density of the laser beam. Therefore, they have a significant influence on the shape of the cutting front and the kerf during the process of cutting. In particular, the curvature of the cutting front is largely determined by the specified parameters and the feed rate of the laser beam. These laser parameters can be used to control which part of the laser beam is absorbed and which part passes through the workpiece.

In a preferred embodiment, the method has the following steps:
c) recording a process image of the entire partial volume of the workpiece with the cutting front penetrated by the laser beam by projecting this partial volume onto a recording surface of an image sensor, wherein the image sensor is arranged above the top side of the workpiece;
d) determining a length of the cutting front in a feed direction of the laser beam in the plane of a beam axis of the laser beam and the feed direction of the laser beam based on the process image.

During the cutting method, the partial volume of the workpiece and in particular the cutting front usually emit a monitoring beam, especially thermal radiation, which can be used to record the process image. The partial volume of the workpiece comprises, in particular at an irradiation time, the cutting front, and the part of the kerf through which the laser beam radiates.

In this embodiment, the part of the laser beam that has passed through the workpiece is determined or estimated by an imaging method using an imaging sensor for cutting process control during the cutting method. For this purpose, a partial volume of the workpiece with the three-dimensional process zone in which the process of cutting takes place is imaged onto the two-dimensional recording surface of the imaging sensor. By taking into account the position and orientation of the sensor (and possibly other optical elements used for imaging) relative to the partial volume of the workpiece with the process zone or cutting zone of the workpiece in which the cutting method takes place, the length of the cutting front can be determined. The process image is recorded in particular by a nozzle from which the laser beam exits. The length of the cutting front makes it possible to easily estimate which part of the laser beam is absorbed by the cutting front.

A further development of the aforementioned embodiment includes determining further parameters of the entire partial volume of the workpiece penetrated by the laser beam based on the process image, in particular geometric parameters and/or the intensity distribution of radiation emitted by the partial volume. The radiation emitted by the partial volume is primarily thermal radiation. The process image of the partial volume can be used to determine not only the length of the cutting front, but also the width and shape thereof. Furthermore, the intensity curve of the cutting front and/or the intensity curve of the entire imaged partial volume can be determined. The determination of such parameters improves the estimation of the size and shape of the cutting front, and thus of the part of the laser beam absorbed by the cutting front.

The beam axis of the radiation for recording the process image preferably has an angle of 0° to 15° to the beam axis of the laser beam, in particular of 0° to 5°, starting from the partial volume of the workpiece. In particular, the beam axis of the thermal radiation emitted by the partial volume, which hits the imaging sensor, is tilted relative to the beam axis of the laser beam. Advantageously, the imaging sensor and, if applicable, the optical elements for guiding the monitoring beam can be arranged outside the spatial area irradiated by the laser beam in this embodiment, so that they are not irradiated and damaged. In particular, the process image can be recorded as part of a simultaneous dragging, piercing and/or vertical observation of the cutting method. The different observation directions can be used advantageously for the calculation of the laser power surplus.

In a further embodiment of the method, a characteristic value of the power of the part of the laser beam that has passed through the workpiece is determined based on the length of the cutting front and the diameter of the laser beam at the top side of the workpiece. The ratio of the length of the cutting front to the diameter of the laser beam provides a simple geometric estimate of the part of the surface of the cutting front that covers the surface of the laser beam in the feed direction and thus an estimate of the part of the laser beam that is absorbed by the cutting front.

A further development of the aforementioned embodiment comprises determining the power of the part of the laser beam that has passed through the workpiece by the surface and/or the intensity distribution of the laser beam on the top side of the workpiece as further parameters. By correlating the parameters of the cutting front determined by the process image with predetermined or measured parameters of the laser beam, it is possible to calculate the power of the laser beam absorbed by the workpiece or the power of the laser beam not absorbed. The parameters of the laser beam include, among others, the caustic thereof, the position of the focus thereof and the intensity distribution thereof, especially along the diameter of the cross-sectional area of the laser beam. For this purpose, the overlap of the area of the cutting front with the cross-sectional area of the laser beam on the surface of the workpiece is preferably considered, wherein this cross-sectional area is essentially determined by the caustic of the laser beam.

In a further variant of the method, at least the partial volume of the workpiece from which a process image is taken is irradiated with incident light illumination, wherein the image data obtained from the reflected incident light illumination are integrated into the process image.

Based on the properties of the reflection behavior of the reflected radiation of the incident light illumination, it can be measured how much material the laser beam hits or will hit with respect to the current feed rate thereof when illuminating the partial volume to record the process image. This information can be used to adjust the laser power surplus compensation. For example, kerfs of existing cuts can be measured using incident light illumination. The incident light illumination is preferably integrated into the machining device, in particular the sensors thereof.

Preferably, the method includes comparing the power of the passed-through part of the laser beam with a first control value for controlling the cutting method. If the first control value is exceeded, the cutting method is adjusted, preferably automatically, to protect the laser processing machine. The laser power surplus is preferably limited to a defined level. In particular, this is done by completely switching off the laser beam, reducing the power of the laser beam and/or increasing the feed rate of the laser beam.

In a further embodiment of the method, the energy radiated over a predetermined time interval in a predetermined area is determined from the part of the laser beam that has passed through. The extent of the possible damage to a machining device used depends essentially on the local and temporal impact of the power of the part of the laser beam that passes through the workpiece. This effect preferably results from a determination of the time-integrated radiation intensity in the area under consideration, which preferably belongs to the machining device. The determination of the radiation intensity takes into account parameters of the process of cutting such as the cutting direction, the cutting speed, the focus position of the laser beam, the diameter of the focus, the gas pressure for generating the gas jet, wherein the gas jet is used in particular for expelling melt, and/or the position of the cutting head within the machining device.

Advantageously, the method includes comparing the radiated energy with a second control value for controlling the cutting method. In particular, the aforementioned radiation intensity can be compared with a limit value, wherein the cutting method is readjusted if the limit value is exceeded, for example by adjusting the laser power or switching off the laser beam.

A machining device for carrying out a method according to one of the aforementioned embodiments has the laser source for emitting the laser beam and the image sensor for recording the process image of the entire partial volume of the workpiece with the cutting front penetrated by the laser beam, and a controller for controlling the method with an evaluation unit for determining the power of the part of the laser beam that has passed through the workpiece. By determining the power of the part of the laser beam that has passed through the workpiece, such a machining device can be effectively protected from damage caused by the laser beam.

The features mentioned above and those still to be further presented can be used in each case individually or together in any desired combinations. The embodiments shown and described should not be understood as an exhaustive list, but rather are of an exemplary character.

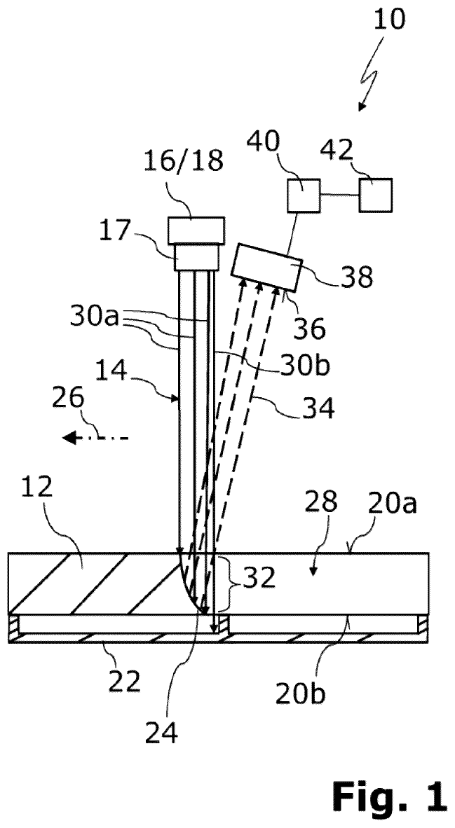

FIG. 1 schematically shows a cross-section through a machining device 10 for controlled cutting of a workpiece 12 with a laser beam 14. A laser beam source 16 which has a focusing device 18 radiates the laser beam 14 through a cutting nozzle generating a gas jet 17 through to a top side 20a of the workpiece 12, which is cut with the laser beam 14 and the gas jet. The cut is made from the top side 20a of the workpiece 12 to the underside 20b thereof, with which the workpiece 12 rests on a support 22. The underside 20b of the workpiece 12 is opposite the top side 20a in the direction of the laser beam 14. The laser beam 14 together with the gas jet generates a cutting front 24 in the workpiece 12, which extends from the top side 20a of the workpiece 12 to the underside 20b thereof and is moved along with the laser beam 14 in a feed direction 26 of the laser beam 14. The cutting front 24 is made by a part 30a of the laser beam 14, wherein the material of the workpiece 12 at the cutting front 24 is melted and/or vaporized by the heating and then expelled from a kerf 28 by the gas jet. This creates the open kerf 28 in the feed direction 26 of the laser beam 14 behind the cutting front 24, through which a part 30b of the laser beam 14 radiates unhindered. This part 30b of the laser beam 14 exits from the underside 20b of the workpiece 12 and strikes the support 22 under the workpiece 12, which is thereby heated and possibly damaged. The part 30b of the laser beam 14 is also referred to as the passed-through part 30b.

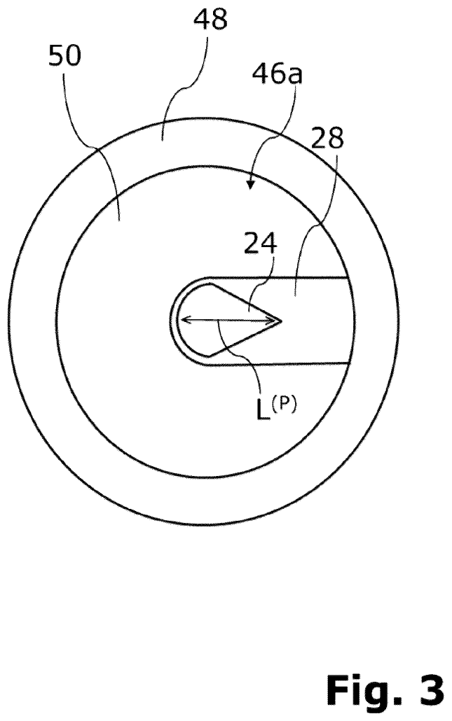

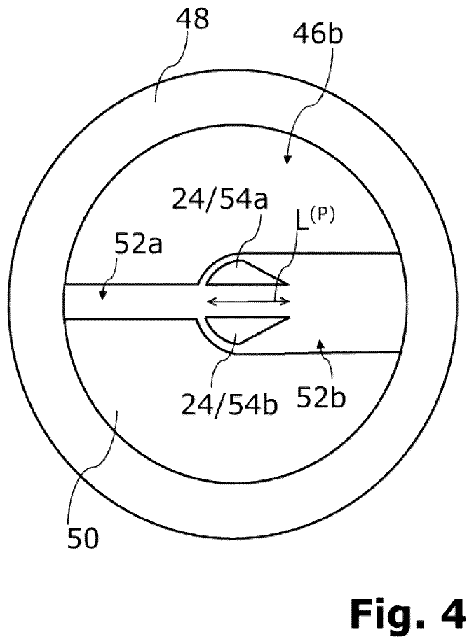

The heated material in the partial volume 32 of the workpiece 12 penetrated by the laser beam 14 with the cutting front 24 emits heat radiation, which at least partially serves as a monitoring beam 34 which strikes a recording surface 36 of an image sensor 38. A controller 40 or control device with an evaluation unit 42 uses the data of the image sensor 38 to create a process image 46a, 46b (see FIGS. 3, 4) of the partial volume 32 of the workpiece 12 penetrated by the laser beam 14 with the cutting front 24. For this purpose, the controller 40, the evaluation unit 42 and the image sensor 38 are connected to one another via signals, as shown in FIG. 1.

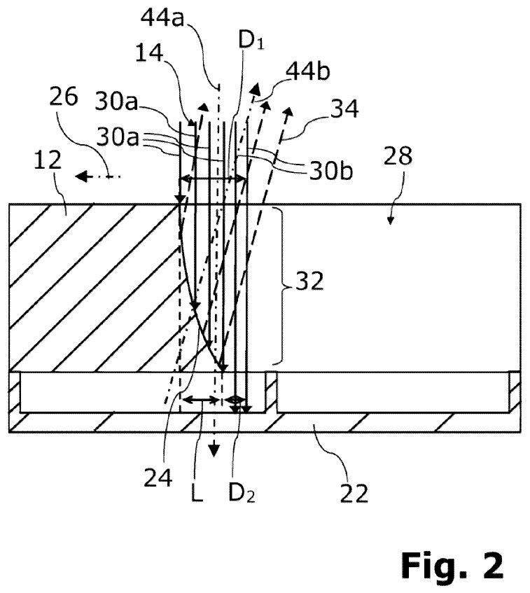

FIG. 2 schematically shows a cross-section through the irradiated workpiece 12 on a support 22. It shows both the part 30a of the laser beam 14 for cutting through the workpiece 12, which strikes the cutting front 24, and the passed-through part 30b of the laser beam 14 that has radiated through the kerf 28 through the workpiece 12 and strikes the support 22 on which the workpiece 12 rests. The diameter D1 of the laser beam 14 on the top side 20a of the workpiece 12, shown in FIG. 2 by a double-sided arrow at the top side 20a of the workpiece 12, is therefore composed of two partial sections. The first partial section is the process length L of the cutting front 24 in the feed direction 26 of the laser beam 14 in the plane of the beam axis 44a of the laser beam 14 and the feed direction 26. The feed direction 26 of the laser beam 14 is from right to left in FIG. 2. The second partial section is the diameter D2 of the passed-through part 30b of the laser beam 14 which radiates through the kerf 28. The diameter D2 is determined in the horizontal direction according to FIG. 2, which runs perpendicular to the laser beam 14. Using the process image 46a, 46b recorded by the image sensor 38, see FIGS. 3, 4 described below, these partial sections L, D2 can be determined and related to the diameter D1 of the entire laser beam 14 on the top side 20a of the workpiece 12 to estimate the passed-through part 30b of the laser beam 14 of the laser beam 14 passing through the kerf 28.

An angle of a beam axis 44b of the monitoring beam 34 to the vertical beam axis 44a of the laser beam 14 is typically 0° to 5°.

FIG. 3 schematically shows a process image 46a of a partial volume 32 (see FIG. 1) of the workpiece 12 irradiated at an irradiation time in a first embodiment of the process of cutting. The process image 46a is recorded by the cutting nozzle 17 (see FIG. 1) from which the laser beam 14 exits, whereby the nozzle mouth 48 thereof surrounds the process image 46a. The process image 46a comprises in particular the cutting front 24, the kerf 28, and a non-cut area 50 of the top side 20a of the workpiece 12 in a projected representation. In the process image 46a, the cutting front 24 has a projected process length L (P) which indicates the length of the cutting front 24 in the horizontal direction according to FIG. 3. From the process image 46a with the projected process length L (P) of the cutting front 24, geometric parameters of the cutting front 24, such as the process length L (P) of the cutting front 24 in the feed direction 26 of the laser beam 14 and/or the width of the cutting front 24, can be determined by imaging methods on the basis of the position and orientation of the image sensor 38 (see FIG. 1) and, if necessary, other optical elements for guiding the monitoring beam 34. The intensity distribution of the monitoring beam 34 can also be determined from the process image 46a.

FIG. 4 schematically shows another process image 46b of a partial volume 32 (sec FIG. 1) of the workpiece 12 irradiated at an irradiation time in a second embodiment of the process of cutting, in which first a cut with a first kerf 52a of smaller width is carried out. This is followed by a cut with a second kerf 52b of greater width, which is guided at least partially along the first kerf 52a. Due to the first kerf 52a, the cutting front 24 is divided into two partial cutting fronts 54a, 54b which are generated on both sides of the first kerf 52a by the laser beam 14 (sec FIG. 1), wherein both partial cutting fronts 54a, 54b have the projected process length L (P). When cutting the second kerf 52b, a part 30b (see FIG. 1) of the laser beam 14 radiates unhindered through the first kerf 52a. This passed-through part 30b of the laser beam 14 can be controlled by the method according to embodiments of the invention to avoid damage to the machining device 10. In addition to the two kerfs 52a, 52b and the partial cutting fronts 54a, 54b, the uncut or not yet cut surroundings 50 of the top side 20a of the workpiece 12 and the nozzle mouth 48 of the cutting nozzle 17 surrounding the further process image 46b are also shown in a projected representation.

As described above, embodiments of the invention relate to a method for monitoring a process of cutting a workpiece 12 with a laser beam 14, in which the workpiece 12 is cut through from a top side 20a to the underside 20b thereof opposite the top side 20a in the beam direction of the laser beam 14. One part 30a of the laser beam 14 is absorbed by a cutting front 24 in the workpiece 12, while another part 30b of the laser beam 14 radiates through a kerf 28 and the underside 20b of the workpiece 12, wherein the kerf 28 lies behind the cutting front 28 in a feed direction 26 of the laser beam 14. In the scope of the method and by means of the machining device, a characteristic value for the power of the passed-through part 30b of the laser beam 14 is determined and the power of the passed-through part 30b of the laser beam 14 which radiates through the kerf 28 is limited.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a process of cutting a workpiece with a laser beam, the method comprising:
a) irradiating a top side of the workpiece with a laser beam;
b) cutting through the workpiece with the laser beam with a cut from the top side of the workpiece to an underside of the workpiece, wherein the underside of the workpiece is opposite the top side of the workpiece in a beam direction of the laser beam, thereby forming a cutting front and a kerf; and
e) limiting a power of a part of the laser beam that has passed through the workpiece to a predetermined level, wherein the part of the laser beam having passed through exits from the workpiece on the underside of the workpiece when cutting through the workpiece.

2. The method according to claim 1, further comprising determining a characteristic value for the power of the part of the laser beam that has passed through the workpiece.

3. The method according to claim 1, further comprising determining the power of the part of the laser beam based on an output power of a laser source for generating the laser beam, a caustic of the laser beam, a Rayleigh length of the laser beam, a position of a focus of the laser beam, a focus position, a focus diameter, a workpiece thickness, and/or a distance of a cutting nozzle from which the laser beam exits to the workpiece.

4. The method according to claim 1, further comprising:
c) recording a process image of an entire partial volume of the workpiece with the cutting front penetrated by the laser beam by projecting the partial volume onto a recording surface of an image sensor, wherein the image sensor is arranged above the top side of the workpiece; and
d) determining a length of the cutting front in a feed direction of the laser beam in a plane of a beam axis of the laser beam and the feed direction of the laser beam based on the process image.

5. The method according to claim 4, further comprising determining further parameters of the entire partial volume of the workpiece penetrated by the laser beam based on the process image, wherein the further parameters comprise geometric parameters and/or an intensity distribution of radiation emitted by the partial volume.

6. The method according to claim 4, wherein an axis of the radiation for recording the process image starting from the partial volume of the workpiece has an angle ranging from 0° to 15° with respect to the beam axis of the laser beam.

7. The method according to claim 4, further comprising determining a characteristic value of the power of the part of the laser beam that has passed through the workpiece based on the length of the cutting front and a diameter of the laser beam on the top side of the workpiece.

8. The method according to claim 7, further comprising determining the power of the part of the laser beam that has passed through the workpiece by an area and/or an intensity distribution of the laser beam on the top side of the workpiece as further parameters.

9. The method according to claim 4, wherein at least the partial volume of the workpiece from which the process image is recorded is irradiated with incident light illumination, wherein image data obtained from reflected incident light illumination are integrated into the process image.

10. The method according to claim 1, further comprising comparing the power of the part of the laser beam with a first control value for controlling the process of cutting the workpiece.

11. The method according to claim 1, further comprising determining an energy radiated over a predetermined time interval in a predetermined area from the part of the laser beam.

12. The method according to claim 11, further comprising comparing the energy with a second control value for controlling the process of cutting the workpiece.

13. The method according to claim 9, wherein the image data obtained from the reflected incident light illumination are used to determine a volume of the workpiece.

14. A machining device set up to carry out a method according to claim 1, the machining device comprising a laser source for emitting the laser beam, an image sensor for recording a process image of an entire partial volume of the workpiece with the cutting front penetrated by the laser beam, and a controller for controlling the process of cutting the workpiece with an evaluation unit for determining a power of the part of the laser beam that has passed through the workpiece.
